(19) United States
(12) Patent Application Publication
(10) Pub. No.: US 2010/0024430 A1
(43) Pub. Date: Feb. 4, 2010

(54) METHOD FOR OPERATING A FIRING SYSTEM

(76) Inventor: Daniel Hofmann, Uttenreuth (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/525,858

(22) PCT Filed: Feb. 6, 2008
(86) PCT No.: PCT/EP08/51434

§ 371 Date: Aug. 5, 2009

(30) Foreign Application Priority Data
Feb. 6, 2007 (EP) 07002562.2

(51) Int. Cl. F23K 5/20; F02C 7/224; F01K 23/06

(52) U.S. Cl. 60/772; 60/39.182; 60/736; 60/670

(57) ABSTRACT

A method for operating a firing system with a combustion chamber, in which a fuel is preheated and is supplied in the preheated state for combustion in the combustion chamber. The preheated temperature of the fuel is set higher for a part load of the firing system than with a basic load. In addition, the preheated temperature of the fuel is set using a variable obtained from the combustion in particular a load of the firing system. A firing system is also provided.

### CROSS REFERENCE TO RELATED APPLICATIONS

This application is the US National Stage of International Application No. PCT/EP2008/051434, filed Feb. 6, 2008 and claims the benefit thereof. The International Application claims the benefits of European application No. 07002562.2 EP filed Feb. 6, 2007, both of the applications are incorporated by reference herein in their entirety.

### FIELD OF INVENTION

The invention relates to a method for operating a firing system with a combustion chamber in which a fuel is preheated and is fed preheated for combustion in the combustion chamber.

### BACKGROUND OF INVENTION

In a firing system gaseous or liquid fuel is supplied to a burner in a combustion chamber and burnt there for heating up an operating medium which is then available to do work. Thus for example ambient air is compressed to a high pressure in a compressor, mixed with combustion gas in a combustion chamber and subsequently burnt. The hot exhaust gas arising from the combustion is directed under very high pressure to a turbine, which is driven by an expansion of the exhaust gas. The shaft of the turbine is connected to a shaft of a generator for generating electrical energy.

Since a gas turbine generates a large amount of waste heat, it is used particularly effectively in conjunction with a steam turbine in a combined process in which the waste heat generated by the gas turbine is used to operate the steam turbine. A gas turbine system and a steam turbine system are combined in this case into one power station unit with an overall level of efficiency.

To improve the efficiency of the gas turbine or of the power station unit it is known for example from EP 0 918 151 B1 that the fuel can be preheated before combustion. To do this heat is extracted from a process step in which the deterioration in efficiency produced thereby is lower than the improvement in efficiency achieved by the fuel preheating. Since the deterioration in efficiency increases with the temperature of the preheating medium extracted, the improvement in overall efficiency declines as the preheating temperature increases.

### SUMMARY OF INVENTION

The object of the present invention is to specify a firing system and a method for operation of a firing system with which a higher level of operational efficiency is able to be achieved.

The object directed towards the method is achieved by the method of the type stated at the start in which, in accordance with the invention, the preheating temperature of the fuel is set as a function of a variable produced by the combustion. A preheating oriented towards the degree of efficiency can also be undertaken during part load operation of the firing system.

In this case the invention is based on the consideration that the maximum preheating temperature of the fuel is predetermined by stability criteria of the combustion. The fuel can only be heated up in so far as a stable combustion is guaranteed with it. To determine the optimum preheating temperature the stability criteria for the basic load at which the firing system is mostly operated are determined and the preheating of the fuel and is set accordingly.

The invention is also based on the consideration that a variable power output is increasingly demanded from power stations—as a requirement of the ever-increasing flexibility of the power market. For a firing system it is thus ever more important, even in part load operation, to operate with a preheating temperature which is good in respect of the level of efficiency. Since the stability of the combustion is also dependent on the instantaneous output or load of the firing system, taking account of the output in setting the preheating temperature can be used to optimize the preheating temperature over wide load ranges of the firing system in respect of the level of efficiency.

In this way an operation-dependent settling of the preheating temperature can be used to keep the level of efficiency of the firing system high even in operating modes other than a basic load operating mode.

In this case of the variable produced from the combustion can be the output or the load of the firing system which increases with the strength of the combustion. Since the load or output is usually determined at regular intervals it is best to control the preheating temperature via the load. The output in this case is an absolute variable which for example can be measured on the basis of a force or on the basis of electrical variables at a generator. The load is an equivalent but relative variable which relates to the output able to be achieved under given conditions at any given moment, e.g. type of fuel, air humidity etc.

With a rotational machine the variable produced from the combustion can be the rotational speed of a component driven by the combustion. In particular the variable is the instantaneous variable with a short time offset of up to 1 minute being possible by which the fuel for example in respect of a load reduction is already preheated more strongly shortly before the reduction in load. The variable in this case is not a rated variable of the firing system but a variable produced directly or indirectly from the combustion which is determined from a measured value for example.

The firing system is advantageously a gas turbine system with a gas turbine. A combined gas and steam turbine system is also conceivable or a steam power station. The operation of the firing system is expediently a regular operation which differs from the start-up mode of the firing system. The fuel is expediently gaseous or liquid.

In an advantageous embodiment of the invention the preheating temperature of the fuel for a part load of the firing system is set higher than for a basic load. At a part load the combustion remains stable at a higher fuel temperature than at full load or the basic load of the firing system. This means that the preheating temperature can be raised at a part load and the level of efficiency of the firing system can be raised at part load in this way.

In a further advantageous embodiment of the invention the preheating temperature of the fuel is set as a function of a flame stability in the combustion chamber. In this way the preheating temperature can always be set in the direction of a high level of efficiency for example so that the combustion is just still stable. The variable produced from the combustion can in this case be the flame stability or a pressure fluctuation in the combustion chamber which can be measured as such or for example as a vibration of the combustion chamber.

If a heat source is available with which the fuel can be preheated to a higher temperature with only a slight loss of efficiency, a preheating temperature which is always at the maximum possible is advantageous. Thus the preheating temperature of the fuel in a further advantageous variant of the invention is basically set to a maximum possible value while adhering to a predefined flame stability. “Basically” can in this context be always during a regular operation, always during operation which does not change over time or always during another type of operation which is free from operational irregularities.

For a flexible use of the firing system said system is frequently started up and shut down depending on the instantaneous demand for energy. Since starting up is a longer process, it is advantageous to be already able to operate at a high-level of efficiency during start-up. The inventive operation-dependent setting of the preheating temperature is also applicable to start-up processes so that it is thus proposed as a further variant of the invention that the fuel is preheated even during the starting up of the firing system and the variable produced from the combustion is a variable of a start-up parameter of the firing system. The variable can be a system parameter or—especially with a gas turbine—a rotational speed of its rotor.

The flame stability is dependent on a series of parameters, for example the air pressure, the air humidity, the rigidity of the fuel supply, on flow states in the combustion chamber etc. Depending on the instantaneous flame stability, the fuel can be preheated to a greater or lesser degree. A good preheating can be achieved in this complex system of parameters when the preheating temperature of the fuel is preset in a first step as a function of a stored assignment and in a second step a precise setting is undertaken with the aid of a measurement result. The stored assignment can link the variable produced from the combustion—for example the instantaneous output of the system—with a preheating temperature, so that a provisional preheating temperature is produced from it to which the system is preset. By measuring a further parameter—for example a flame stability by measuring a pressure fluctuation—the preheating temperature can be further improved in respect of the level of efficiency.

The object oriented towards the firing system is achieved by a firing system of the type stated at the start which inventively comprises a control means for setting the preheating temperature of the fuel as a function of a variable produced from the combustion. The preheating temperature can be set depending on operation and a higher efficiency of the firing system can be achieved for different modes of operation.

The control means can be a control unit with a corresponding control program which for example contains a stored assignment of one or more operating parameters of the firing system relating to preheating temperatures. The fuel supply is a means for carrying fuel during operation which can comprise one or more lines.

In an advantageous embodiment of the invention of the heating means features at least two heat exchangers arranged in the fuel supply line which are connected to heating stages of different operating temperature. Heat can be extracted both from a relatively cool heat carrier with only a slight loss of efficiency and also additionally heat from a warmer heat carrier for further heating of the fuel to a high and efficiency-friendly temperature. The heating stages can be embodied in a high, medium or low-pressure preheater, for example in the form of heat exchangers in a waste heat guide of a gas turbine or as a cooling element in the system, for example for cooling turbine blades.

In an alternate and low-cost embodiment of the invention the heating means comprises only one heat exchanger through which a hot preheating medium flows during operation.

Advantageously the heat exchangers are arranged serially in the fuel feed. Thus the fuel can be initially heated up by one heat exchanger and subsequently reheated by the second heat exchanger. A heat exchanger connected to the cooler heating stage is arranged in the fuel flow before the heat exchanger connected to the warmer heating stage, the heating energy of the warmer rear heat exchanger can be restricted to a reheating of the fuel which is associated with a lower heat loss of the warmer heating stage.

In an alternative embodiment of the invention the heat exchangers are arranged in parallel in the fuel feed, by which a high flexibility in the selection of the supply of heat to the fuel can be achieved.

Advantageously the fuel feed comprises at least two parallel lines each directing a part flow of the fuel to one of the heat exchangers, with the fuel part flows being merged by the lines after the heat exchangers. Depending on the preheating temperature the fuel flows can be distributed so that the heating warmth from above all the cooler heat exchangers is able to be used as fully as possible. The control means in this case can divide up the part flows quantitatively to the two lines to achieve the desired fuel temperature.

A loss of efficiency by the preheating can be kept low when the control means is provided to relieve the load on the heat exchanger connected to the cooler heating stage and include the other heat exchanger for further heating up of the fuel. Further heating in this case can be seen as an additional heating up beyond the heating up by the cooler heat exchanger. With a serial arrangement the warmer heat exchanger can be used further temperature increase of the heated-up fuel and in a parallel arrangement for greater heating of the one part flow.

Particularly with a method of operation such that the preheating temperature of the fuel is preset in a first step depending on a stored assignment and in a second step is subject to a precise setting with the aid of a measurement results, it is advantageous for the control means to be embodied as self-learning in respect of the control of the preheating temperature, i.e. provided with a corresponding program. In this case for example the stored assignment can be ever further adapted by the self learning to the system and/or priority operating modes of the operator, so that a presetting becomes ever more accurate.

### BRIEF DESCRIPTION OF THE DRAWINGS

The invention will be explained in greater detail on the basis of exemplary embodiments which are shown in the drawings. The drawings are as follows:

FIG. 1 a diagram in which the efficiency of a gas turbine system is plotted as a function of a preheating temperature of the fuel burnt in the gas turbine of the gas turbine system,

FIG. 2 a diagram in which the efficiency of a combined cycle system is plotted as a function of a preheating temperature of the fuel, taking into consideration the energy required to the preheating,

FIG. 3 a combined cycle system with a heating means for preheating fuel,

FIG. 4 a fuel feed scheme for a combustion chamber of a gas turbine system,

FIG. 5 a diagram of the heating means for preheating fuel and

FIG. 6 a diagram of an alternate heating means for preheating fuel.

### DETAILED DESCRIPTION OF INVENTION

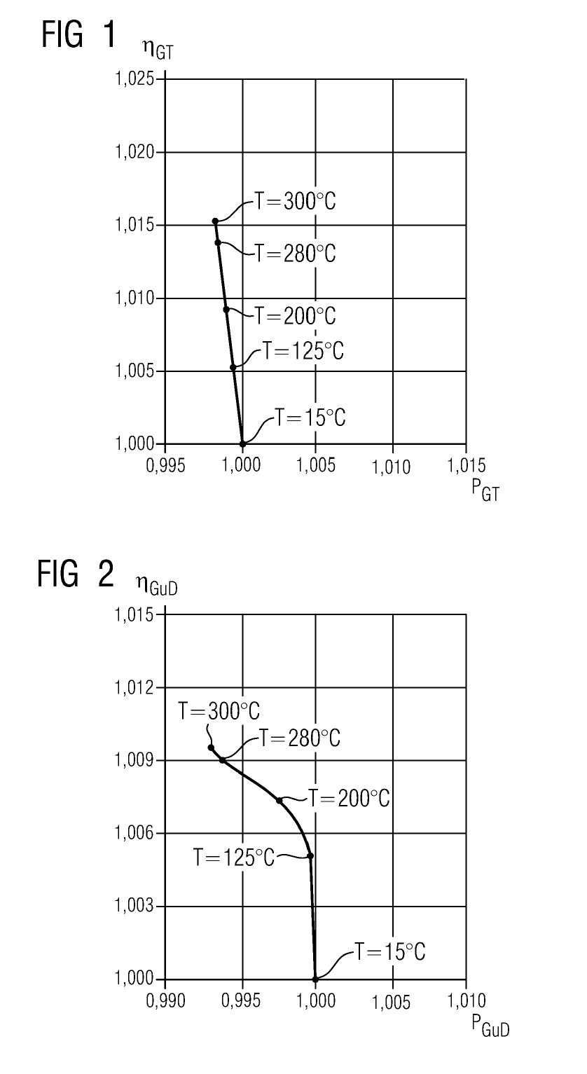

FIG. 1 shows a diagram in which the efficiency η_{GT} of a gas turbine system of a combined cycle (gas and steam turbine system) is plotted as a function of the preheating temperature of the fuel burned in the combustion chamber of the gas turbine system. A fuel temperature of 15° C. is selected as the starting point at which the efficiency η_{GT} of the gas turbine system is specified with 100% and the output of the gas turbine system likewise with 100%. As the preheating temperature of the fuel delivered to the combustion chamber increases, the level of efficiency η_{GT} increases in a linear manner and the output P_{GT} of the gas turbine reduces slightly. At a preheating temperature of the fuel of 300° C. an efficiency η_{GT} of 101.5% can be achieved, in which case the output P_{GT} at 99.8%, has fallen somewhat.

If the energy needed for preheating which is taken from an operating process of the combined cycle system is included in the efficiency computation, an efficiency η_{GuD} of the overall combined cycle system which depends on the fuel preheating is produced, which is shown in FIG. 2. Up to around 125° C. the efficiency η_{GuD} of the combined cycle system increases in a linear manner. At the low preheating temperatures energy can be used for preheating which is not used in the steam turbine process. From a preheating temperature of about 125° C. and above, heat also able to be used in the steam turbine process is used for preheating which is thus no longer available for producing output of the steam turbine. The output η_{GuD} of the combined cycle system thus falls increasingly as the preheating temperature rises. Despite this is an increase in the efficiency η_{GuD} of the combined cycle system up to a preheating temperature of 300° C. and more is able to be achieved for as long as the combustion remains stable in the combustion chamber.

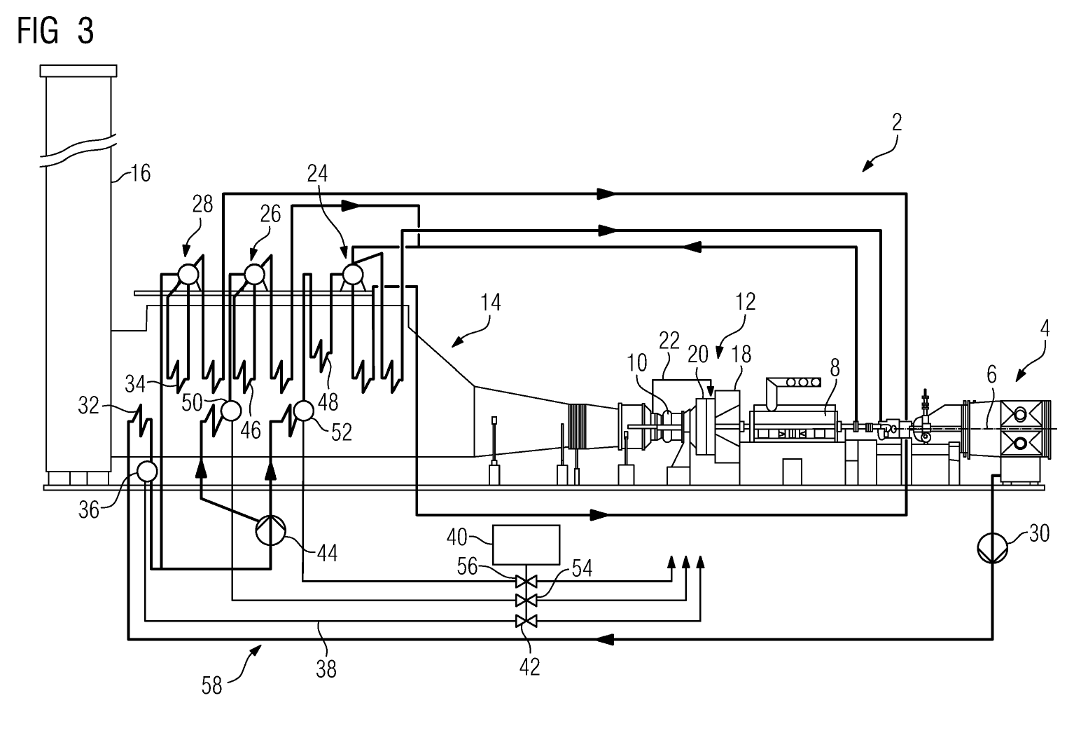

FIG. 3 shows a combined cycle system 2 in a schematic overview. It comprises a steam turbine 4, of which the rotor is connected via a shaft 6 to a generator 8. This in its turn is connected to the rotor of a gas turbine 10 which is part of a firing system 12. On the exhaust gas side of the gas turbine a waste heat steam generator 14 is arranged which is heated with the waste heat of the gas turbine 10. The waste gases leave the combined cycle system 2 via a chimney 16.

The firing system 12 comprises a compressor 18 for compressing combustion air which will be fed to a combustion chamber 20. Here it is mixed with preheated fuel and the mixture is burnt. Heat from preheating the fuel can be removed from various points of the combined cycle system 2. Thus compressed combustion air can be routed from the compressor 16 to the turbine part of the gas turbine 10 and be used there for cooling turbine blades. The air heated up in this way is fed back via lines 22 and used for preheating the fuel.

As an alternative or in addition heat can be extracted from the steam system of the combined cycle system 2, for example from the waste heat steam generator 14. The waste heat steam generator 14 comprises a high-pressure stage 24, a medium-pressure stage 26 and a low-pressure stage 28. The hot waste gas exiting from the gas turbine 10 initially flows through the high-pressure stage 24, which is heated up the most, then through the medium precious stage 26 and lastly through the low-pressure stage 28. Condensate is pumped by means of the condensate pump 32 to a preheater 32 where the condensate is preheated. Before the preheated condensate is directed to a low-pressure preheater 34 it can emit heat in a heating stage 36 embodied as a heat exchanger for example for low-temperature preheating of the fuel. Via lines 38 and through a valve 42 activated by a control means 40 the preheating medium arrives at a heat exchanger not shown in FIG. 2 for transferring the heat to the fuel.

Via a feed water pump 44 the preheated condensate is also fed under medium and high pressure to a medium-pressure preheater 46 or a high-pressure preheater 48. Before this, as a heat carrier, it can output heat in a heating stage 50 also embodied as a heat exchanger for medium-temperature preheating of the fuel. Optionally an even hotter heating stage 52 can be provided for high-temperature preheating of the fuel. The corresponding supply of the heat to the fuel is brought about by the control means 40 by means of further valves 54, 56. By the arrangement of the heating stages 36, 50, 52 in the waste heat steam generator or in its vicinity the operating temperatures of the heating stages 36, 50, 52 are different. Depending on the desired preheating temperature of the fuel, heat is extracted from the heat carrier only in the coolest heating stage 36 or also in the heating stage 50 or even the heating stage 52.

The heating stages 36, 50, 52, the control unit 40 and the lines 38 with the valves 42, 54, 56 as well as the heat exchanger not shown in the diagram for heat transmission to the fuel are a component of a heating means 58 for preheating the fuel.

In a favorable alternative as regards investment costs the heating means comprises on its heat receiving side only one single heat exchanger, for example that of the heating stage 50, which extracts heat for all preheating temperatures of the fuel from the heat carrier.

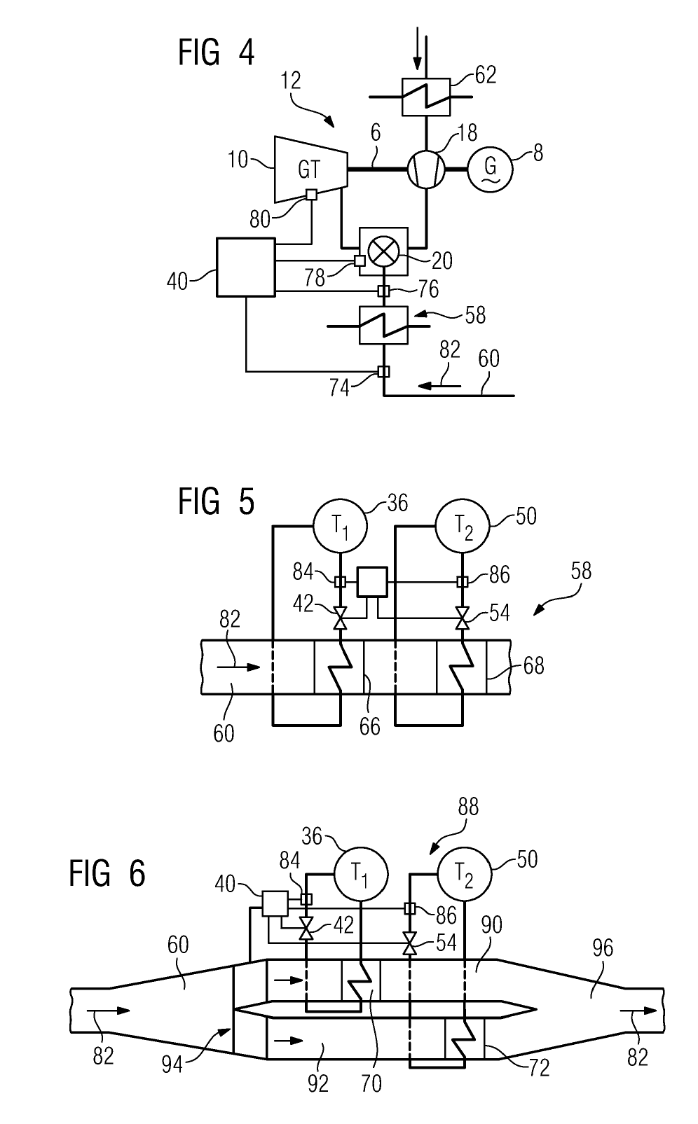

The firing system 12 with the gas turbine 10 and a fuel feed 62 to the combustion chamber 20 is shown in FIG. 4 in a somewhat more detailed schematic diagram. Combustion air directed to the combustion chamber 20 is preheated in a heat exchanger 62. The fuel is preheated by the heating means 58 only shown schematically in FIG. 4, which on the heat emitting side can comprise one or more heat exchangers 66, 68, 70, 72 (see FIGS. 5 and 6). The fuel preheating is controlled by the control means 40 which detects via a sensor 74 the temperature of the as yet not preheated fuel and via a sensor 76 the temperature of the preheated fuel. A flame stability is determined by the control means 40 via another sensor 78 on or in the combustion chamber 20. By means of a further sensor 80 which can be arranged on the gas turbine 10 or at another suitable point, the output or load of the firing system 12 or the gas turbine 10 respectively are detected.

As shown in FIG. 5, the heating means 58 is embodied with two heat exchangers 66, 68 which are arranged serially in the fuel feed 60. Optionally a third heat exchanger is possible which obtains heat from the optional heating stage 52 which however is omitted from the figure for the sake of clarity The fuel flowing in the direction of flow 82 during operation first reaches the heat exchanger 66 which is connected to heating stage 36. The heating stage 36 in its turn is supplied with heat by the heat carrier of operating temperature T₁ of 130° C., namely the preheated condensate. Through this the preheating medium is heated up in the heating circuit of heat exchanger 66 to 125° C. for example. The fuel then reaches the heat exchanger 68, which is connected to the heating stage 50 with the higher operating temperature. The heating stage 50 is supplied with heat by the heat carrier of the warmer operating temperature T₂ of 210° C., namely the condensate which is supplied to the medium-pressure preheater 46. This heats the preheating medium in the heating circuit of the heat exchanger 68 to 200° C. for example. The control means 40 uses sensors 84, 86 in each case to determine the temperature of the preheating medium in the two heating circuits of the heating means 58.

An alternate heating means 88 with two heat exchangers 70, 72 arranged in parallel to each other is shown in FIG. 6. The description below restricts itself essentially to the differences compared to the exemplary embodiments depicted in FIG. 5, to which the reader is referred in respect to features and functions which remain the same. Essentially components which remain the same are basically labeled with the same reference characters. Each of the heat exchangers 70, 72 is arranged in a separate line 90, 92 which are routed in parallel to each other. The fuel flows through a distribution means 94 activated by the control means 14 which distributes the flow of fuel to the two lines 90, 92. After preheating of the fuel the two fuel flows are combined again in a merging zone 96 into one fuel flow with the desired preheating temperature.

During the operation of the combined cycle system 2 the preheating temperature of the fuel is set as a function of a variable produced by the combustion. In a simple variant of the invention this is the load of the gas turbine 10 or of the combined cycle system 2 which is detected by the control means 40 with the aid of the sensor 80 for example.

In this case the preheating temperature, i.e. the temperature measured in sensor 76 with which the fuel reaches the combustion chamber 20, is set higher for a part load operation of the combined cycle system 2 or of the gas turbine 10 or the firing system 12 respectively than for basic load or full load operation. In a more complex variant of the invention the preheating temperature will be set as a function of a flame stability of the combustion in the combustion chamber 20. In this case the preheating temperature can initially be preset on the basis of the load as a function of an assignment stored in a control means 40, and then set more precisely or corrected on the basis of the flame stability. The control means 40 detects the flame stability for example with the help of the sensor 78, e.g. on the basis of a pressure fluctuation in the combustion chamber 20 or a vibration of the combustion chamber 20. In an additional control program of the control means 40 able to be selected by operating personnel the preheating temperature is basically regulated to a maximum possible value while complying with a prespecified flame stability.

Regardless of the setting of the preheating temperature priority is given by the control means to loading the heat exchangers 66, 70 connected to the cooler heating stage 36 so that as few high temperature heat carriers as possible are cooled and as little usable warmth is withdrawn from the steam process as possible. Thus the fuel is heated if possible completely or a least as far as possible by the cooler heat exchangers 66, 70 and the hotter heat exchangers 68, 72 are only used to further increase the fuel temperature or provide hotter fuel for mixing with the fuel heated to the maximum possible temperature by the heat exchanger 70. Accordingly the flows of preheating medium through the heat exchangers 66, 68 or the fuel flows through the heat exchangers 70, 72 are set by the control means.

A further control program of the control means 40 makes it possible for the control means itself to learn during the setting of the preheating temperature. The preheating temperature subject to precise adjustment with the aid of a measurement results is linked in each case to operating parameters obtaining in the firing system 12 or the combined cycle system 2. If at a later time an operating point which is the same or similar in respect of the operating parameters is reached, the stored preheating temperature is adjusted and if necessary set even more precisely by further measurements.

With the method described the fuel can be preheated even during start-up of the firing system well in accordance with stored data, for example with the aid of a variable of a start-up parameter of the firing system 12 and/or measurement results, so that a higher level of efficiency of the firing system is rapidly achieved.

1.-3. (canceled)

4. A method for operating a firing system including a combustion chamber, comprising:
preheating a fuel; and
supplying the preheated fuel for combustion in the combustion chamber,
wherein a preheating temperature of the fuel is set higher for a part load of the firing system than the preheating temperature of the fuel for a basic load, and
wherein the preheating temperature of the fuel is a variable which is set as a first function of a flame stability in the combustion chamber.

5. The method as claimed in claim 4, wherein the preheating temperature of the fuel is set to a maximum possible value while adhering to a predetermined flame stability.

6. The method as claimed in claim 4, further comprising presetting the preheating temperature of the fuel in a first step as a second function of a stored assignment and more precisely setting the preheating temperature in a second step with an aid of a measurement result.

7. A firing system, comprising:
a combustion chamber;
a compressor;
a control unit for setting the preheating temperature of a fuel as a function of a variable produced from combustion;
a fuel supply; and
a heating unit,
wherein a preheating temperature of the fuel is set higher for a part load of the firing system than the preheating temperature of the fuel for a basic load.

8. The firing system as claimed in claim 7, wherein the heating unit comprises at least two heat exchangers arranged in a fuel supply line and the two heat exchangers are connected to a plurality of heating stages of different operating temperatures.

9. The firing system as claimed in claim 7, wherein the heating unit comprises one heat exchanger.

10. The firing system as claimed in claim 7, wherein the plurality of heat exchangers are arranged serially in a fuel feed.

11. The firing system as claimed in claim 7, wherein the plurality of heat exchangers are arranged in parallel in the fuel feed.

12. The firing system as claimed in claim 7, wherein the firing system is a gas turbine system.

13. The firing system as claimed in claim 12, wherein the variable is a rotational speed of a rotor.

14. The firing system as claimed in claim 7, wherein the firing system is a combined gas and steam turbine system.

15. The firing system as claimed in claim 7, wherein the firing system is a steam power station.

16. The firing system as claimed in claim 7, wherein the control unit uses a plurality of sensors to determine a temperature of the fuel.
